(19) United States
(12) Patent Application Publication
(10) Pub. No.: US 2018/0029612 A1
(43) Pub. Date: Feb. 1, 2018

(54) SAFE DRIVING BEHAVIOR NOTIFICATION SYSTEM AND SAFE DRIVING BEHAVIOR NOTIFICATION METHOD

(71) Applicants: FUJITSU TEN LIMITED, Kobe-shi (JP); WASEDA UNIVERSITY, Tokyo (JP)

(72) Inventors: Masashi TSUYUNASHI, Kobe-shi (JP); Harutoshi OGAI, Tokyo (JP); Nan WU, Tokyo (JP); Thatchaphol MOTANEEYACHART, Tokyo (JP)

(73) Assignees: FUJITSU TEN LIMITED, Kobe-shi (JP); WASEDA UNIVERSITY, Tokyo (JP)

(21) Appl. No.: 15/665,734

(22) Filed: Aug. 1, 2017

(30) Foreign Application Priority Data
Aug. 1, 2016 (JP) 2016-151313

(51) Int. Cl. B60W 50/14; B60W 40/112; B60W 40/09; B60W 30/095; B60W 50/00

(52) U.S. Cl. CPC B60W 50/14; B60W 30/095; B60W 50/0097; B60W 40/09; B60W 40/112

(57) ABSTRACT

A safe driving behavior notification system includes: an obstacle detector to detect position of each obstacle existing around a subject vehicle; a first specifier to specify driving behavior to be carried out by a driver based on the detected position of each obstacle and information relating to the subject vehicle; a second specifier to specify driving behavior predicted to be carried out by the driver from the detected position of each obstacle and information on a travel state of the subject vehicle using a driving behavior model for the driver created based on past driving behavior of the driver; and a notificator to determine whether notification to the driver is necessary based on a degree of a difference between the driving behaviors specified by the first and second specifiers, and to notify the driver of information indicating action to be carried out when determining the notification is necessary.

### CROSS-REFERENCE TO RELATED APPLICATION

This application claims the benefits of Japanese Patent Application No. 2016-151313, filed on Aug. 1, 2016, the entire contents of which are incorporated herein by reference.

### BACKGROUND

### Technical Field

The present invention relates to a safe driving behavior notification system and a safe driving behavior notification method for supporting driving of a vehicle.

### Description of the Related Art

There are developed a variety of techniques to enable a driver to drive a vehicle safely. For example, JP1999339196A describes a device which determines whether the risk of entering the front curve is high taking the driving skill of the driver into consideration, and, when determining the risk is high, notifies the driver of the fact. Further, JP2010097480A describes a technique to specify an advice for a driver based on the past driving behavior and the running environment in which a vehicle runs from now, and then informing the driver of the advice at a time of engine start.

### SUMMARY

A driver with a high driving skill does not feel that the traveling in a curve is dangerous unless the bending of the curve is considerably tight. Accordingly, by using the technique described in JP1999339196A which determines whether the risk of entering the front curve is high considering the driving skill of the driver, it is possible to suppressed useless notification to the driver from being made. However, in cases where the technique described in JP1999339196A is used, it follows that a numerical data indicating the driving skill of the driver is set by the driver himself/herself. Consequently, with the technique described in JP1999339196A there is a possibility that notification to the driver is not appropriately performed in cases where the driving skill is not set appropriately.

Embodiments of the present disclosure provide a safe driving behavior notification system and a safe driving behavior notification method that notifies a driver of information for safe driving.

Embodiments of the present disclosure include a safe driving behavior notification system in an embodiment to be equipped in a vehicle. The safe driving behavior notification system includes: an obstacle detector configured to detect position of each obstacle existing around a subject vehicle; a first specifier configured to specify driving behavior to be carried out by a driver of the subject vehicle based on the position of each obstacle detected by the obstacle detector and information relating to the subject vehicle; a second specifier configured to specify driving behavior predicted to be carried out by the driver from the position of each obstacle detected by the obstacle detector and information on a travel state of the subject vehicle using a driving behavior model for the driver which is created based on past driving behavior of the driver; and a notificator configured to determine whether notification to the driver is necessary, based on a degree of a difference between the driving behavior specified by the first specifier and the driving behavior specified by the second specifier, and to notify the driver of information indicating action to be carried out by the driver, when it is determined that notification to the driver is necessary.

Namely, the safe driving behavior notification system according to an embodiment has a constitution of determining whether or not notification to the driver is required based on the comparison result of the driving behavior to be carried out by the driver which is obtained from position of each obstacle and the driving behavior of the driver which is predicted using the driving behavior model that is created from the past driving behavior of the driver. By using the driving behavior model that is created from the past driving behavior of the driver, it is possible to predict the driving behavior of the driver precisely compared to when using other driving behavior models (for example, driving behavior model for average drivers who are close in age). Consequently, according to the safe driving behavior notification system of this embodiment, it is possible to make the notification to the driver in an appropriate manner and to prevent useless notification from being given to the driver.

The safe driving behavior notification system may include a physical condition detector configured to detect physical condition of the driver, and have configuration where the driving behavior model is created based on the past driving behavior of the driver and physical condition of the driver at the time of each driving behavior, and the second specifier is configured to specify the driving behavior predicted to be carried out by the driver from the position of each obstacle detected by the obstacle detector, the physical condition detected by the physical condition detector and the information on the travelling state of the subject vehicle using the driving behavior model. With this constitution, it is possible to prevent useless notification from being given to the driver without depending on the physical condition of the driver.

To the safe driving behavior notification system, constitution where the obstacle detector is configured to detect position and category of each obstacle existing around the subject vehicle, and the first specifier is configured to specify the driving behavior to be carried out by the driver based on a risk potential map that is created such that risk potential for each area to which each obstacle moves with high possibility is high and the information on the travelling state of the subject vehicle, may be adopted. With this constitution, it is possible to obtain the safe driving behavior system that operates as a system in which necessity of the notification is not erroneously determined due to the inaccurate driver behavior being specified.

To the safe driving behavior notification system, constitution where the notificator is configured to determine whether the notification to the driver is necessary by determining whether the degree of the difference is equal to or smaller than a threshold value, and the safe driving behavior notification system further comprises a threshold changer configured to monitor reaction of the driver for a prescribed period of time after determination of the necessity of notification is made by the notificator, may be adopted. With this constitution, it is possible to automatically change the notification timing to the timing that is appropriate to the driver.

To the safe driving behavior notification system, constitution where a load detector configured to detect an auditory load and a visual load of the driver is included, and the notificator is configured to include a text display function to notify the driver of the information indicating the action to be carried out by the driver through text message and a voice output function to notify the driver of the information indicating the action to be carried out by the driver through voice message, and to notify, when the auditory load detected by the load detector is equal to or larger than a first predetermined load, the driver of the information indicating the action to be carried out by the driver using, without using the voice output function, the text display function, may be adopted. With this constitution, it is possible to prevent the visual load of the driver from increasing excessively.

To the safe driving behavior notification system, together with the above constitution, constitution where the notificator is configured to notify the driver of the information indicating the action to be carried out by the driver using, without using the text display function, the voice output function when the visual load detected by the load detector is equal to or larger than a second predetermined load and the auditory load detected by the load detector is smaller than the first predetermined load, and to notify the driver of the information indicating the action to be carried out by the driver using, without using the voice output function, the text display function when the visual load detected by the load detector is smaller than the second predetermined load and the auditory load detected by the load detector is equal to or larger than the first predetermined load, may be adopted. With this constitution, it is possible to prevent the auditory load of the driver from increasing excessively.

Further, embodiments of the present disclosure include a safe driving behavior notification method carried out by a computer for notifying a driver in a subject vehicle of information indicating action to be carried out by the driver, and the method includes: a first specifying step of specifying driving behavior to be carried out by the driver based on position of each obstacle existing around the subject vehicle and information relating to the subject vehicle; a second specifying step of specifying driving behavior predicted to be carried out by the driver from the position of each obstacle detected by the obstacle detector and information on a travel state of the subject vehicle using a driving behavior model for the driver which is created based on past driving behavior of the driver; and a notification step of determining whether notification to the driver is necessary based on a degree of a difference between the driving behavior specified in the first specifying step and the driving behavior specified in the second specifying step, and of notifying the driver of information indicating action to be carried out by the driver, when it is determined that the notification to the driver is necessary.

Namely, by the safe driving behavior notification method, determination of whether or not notification to the driver is required is made based on the comparison result of the driving behavior to be carried out by the driver which is obtained from position of each obstacle and the driving behavior of the driver which is predicted using the driving behavior model that is created from the past driving behavior of the driver. Accordingly, by the safe driving behavior notification method, it is possible to make the notification to the driver in an appropriate manner and to prevent useless notification from being given to the driver.

### BRIEF DESCRIPTION OF THE DRAWINGS

FIG. 1 is a schematic structural view of a safe driving behavior notification system in an embodiment of the present invention.

FIG. 2 is a flow chart of safe driving behavior notification processing performed periodically by the control unit.

FIG. 3A is an explanatory diagram of processing of steps S103 and S104.

FIG. 3B is another explanatory diagram of processing of steps S103 and S104.

FIG. 4A is first explanatory diagram of a method of notifying a driver of information by safe driving behavior notification.

FIG. 4B is second explanatory diagram of a method of notifying a driver of information by safe driving behavior notification.

FIG. 4C is third explanatory diagram of a method of notifying a driver of information by safe driving behavior notification.

### DETAILED DESCRIPTION

### Description of Embodiments

Embodiments of the present invention will hereinafter be described with reference to the accompanying drawings. Note that configuration of the embodiments described below is illustrative, and the present invention is not limited to the configuration of the embodiments.

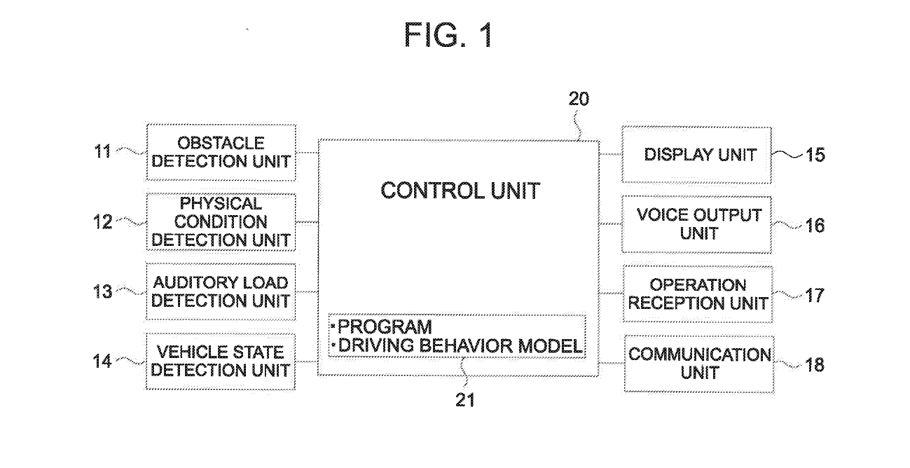

FIG. 1 is a schematic structural view of a safe driving behavior notification system in an embodiment of the present invention. The safe driving behavior notification system of this embodiment is a system that is used by being equipped in a vehicle. As illustrated in FIG. 1, the safe driving behavior notification system includes an obstacle detection unit 11, a physical condition detection unit 12, an auditory load detection unit 13, a vehicle state detection unit 14, a display unit 15, a voice output unit 16, an operation reception unit 17, a communication unit 18 and control unit 20.

The obstacle detection unit 11 is a unit that collects information about each obstacle existing forward of a vehicle in which the safe driving behavior notification system is equipped (which will hereinafter be called a subject vehicle) In other words, the obstacle detection unit 11 collects information about each obstacle existing within a predetermined angle range of the travelling direction of the subject vehicle. Note that the information collected by the obstacle detection unit 11 is information showing position and category (human, vehicle, etc.) of each obstacle. As the obstacle detection unit 11, it is possible to adopt two or more cameras for photographing forward areas of the subject vehicle, a combination of one or more cameras for photographing forward areas of the subject vehicle and radar that emits millimeter wave or infrared light ahead of the subject vehicle or the like.

The physical condition detection unit 12 is a unit for detecting physical condition of the driver of the subject vehicle. The behavior (variation pattern of visual line direction of the driver, movement of the body, etc.) of the driver varies with his/her physical condition. Therefore, the camera that is arranged in the subject vehicle so as to be able to photograph the state of the driver can be used as the physical condition detection unit 12. Further, as the physical condition detection unit 12, a device (which is carried by the driver) to detect body temperature and/or heart rate of the driver may be used alone or with a camera for monitoring the behavior of the driver.

The auditory load detection unit 13 is a unit for detecting the auditory load of the driver. As the auditory load detection unit 13, a microphone to measure the sound volume level in the vehicle can be used. A unit that obtains the sound volume level from another device (a car audio device, etc.) that generates sounds, i.e., an interface unit to communicate with another device, can be also used as the auditory load detection unit 13. Incidentally, the auditory load detection unit 13 is preferably one that can detect the voice of the driver.

The vehicle state detection unit 14 is a unit that detects various information (operation quantities of a steering wheel, an accelerator pedal and a brake pedal, a vehicle speed, a state of the ignition key) relating to the subject vehicle. The vehicle state detection unit 14 may be a unit that obtains each required information from other devices or a unit that measures each required information.

The display unit 15 is a unit to display a text message. A liquid crystal display (LCD) is typically used as the display unit 15. The voice output 16 is a speaker to output voices and so on. The operation reception unit 17 is a unit to accept an input operation of information by a user. It is possible to adopt several push button switches, a transparent contact position detection sensor laid on the display unit 15 (LCD) or the like as the operation reception unit 17.

The communication unit 18 is a unit for performing wireless communication between a driving behavior model management server (which will be mentioned in depth later on). As the communication unit 18, a unit that communicates using WiMAX (registered trademark) or LTE can be adopted, for example.

The control unit 20 is a unit (computer) that is constructed from a CPU (not illustrated), a volatile storage (not illustrated), a non-volatile storage 21 and so on. The non-volatile storage 21 of the control unit 20 stores a program which is read into volatile storage and then executed by the CPU. The control unit 20 functions as a unit that performs safe driving behavior notification processing periodically by virtue of the CPU executing the program.

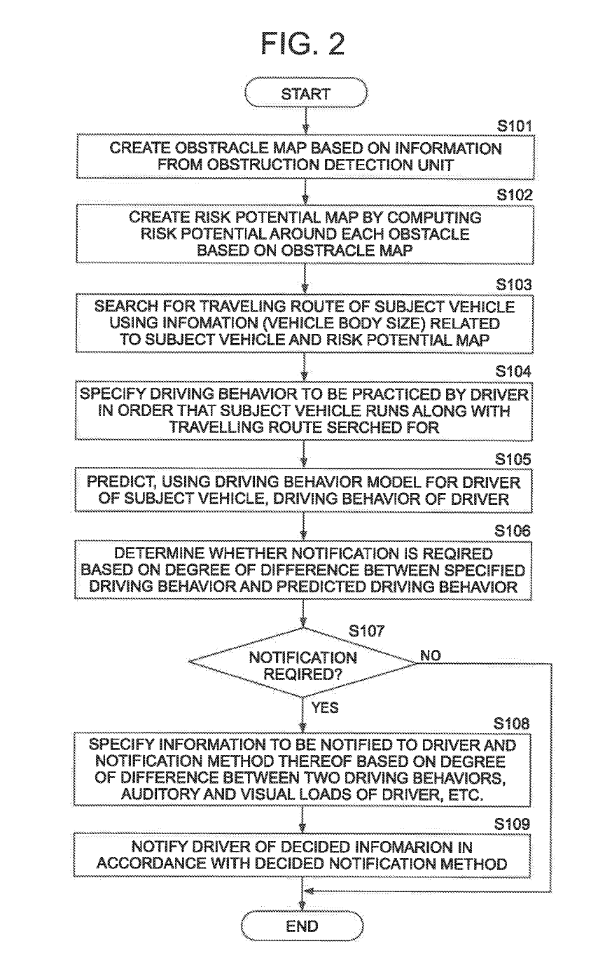

The safe driving behavior notification processing that is periodically performed by the control unit 20 is processing in a procedure shown in FIG. 2. In advance of a detailed discussion on the safe driving behavior notification processing, a driving behavior model that is a calculating formula (calculation algorithm) used in the safe driving behavior notification processing and operation of the control unit 20 at the first time of power on (at initial setting) will be explained.

When a power supply is turned on for the first time, the control unit 20 displays on the display unit 15 messages of inputting an age, a sexuality and a driving skill level by the operation of the operation reception unit 17. Herein, the driving skill level is defined as a numerical value showing the level of driving skill.

When the input of the age, the sexuality and the driving skill level (these data will hereinafter be referred to as driver information) by the driver is finished, the control unit 20 transmits using the communication unit 18 a driving behavior model request containing the input driver information to the driving behavior model management server in order to obtain a driving behavior model.

The driving behavior model is a model (calculating formula) for obtaining (forecasting) the driving behavior that will be carried out by the river from several kinds of information on the state of the vehicle (positions of obstacles existing forward of the vehicle, vehicle speed, etc.). Note that the “driving behavior” that can be obtained using the driving behavior model is time-series data of the operation quantities of the brake pedal, the accelerator pedal and the steering wheel.

Even if the situations of the vehicles are the same, drivers whose ages and/or sexualities and/or driving skill levels differ carry out different driving behavior. Therefore, in the driving behavior model management server, a driving behavior model is prepared for each combination of age division, sexuality and driving skill level. The driving behavior model management server, when receiving the driving behavior model request, sends back the driving behavior model associated with the driver information in the received driving behavior model request to the control unit 20 that has transmitted the driving behavior model request.

Further, even if the situations of the vehicles and driver information are the same, respectively, there are individual differences in the driving behavior carried out by drivers. Furthermore, the driving behavior may vary by the physical condition of the driver. Therefore, the driving behavior model management server is provided with a function to create the driving behavior model for each driver, which can forecast the driving behavior taking the physical condition into consideration, from the real driving behavior of each driver.

Hereinafter, operations of the driving behavior model management server and the control unit 20 relating to the above function will be discussed. For convenience of explanation, in the following discussion, the driving behavior model that is prepared in the driving behavior model management server in advance will be referred to as a first driving behavior model, and the driving behavior model that is created for each driver based on the real driving behavior of each driver and the like will be referred to as a second driving behavior model.

The control unit 20 that has obtained a driving behavior model from the driving behavior model management server by transmitting the driving behavior model request, stores the driving behavior model in both of the volatile storage and the non-volatile storage 21. Then, the control unit 20 becomes in a state where it performs the safe driving behavior processing (FIG. 2; details will be discussed later) using the driving behavior model in the volatile storage. Note that, when being restarted, the control unit 20 reads the driving behavior model that is stored in the non-volatile storage 21 into the volatile storage, and then becomes in the above state.

The control unit 20 constantly stores inside the physical condition and the driving behavior of the driver, monitoring results of the situation in front of the subject vehicle. When the amount of monitoring results exceeds a prescribed value, the control unit 20 transmits monitoring result information that contains the monitoring results to the driving behavior model management server. Note that the monitoring results in the monitoring result information that the control unit 20 transmits to the driving behavior model management server are only the monitoring results that meets a predetermined condition (e.g. the monitoring results showing that the driver performed operation to avoid an obstacle). Further, the control unit 20 discards (erases) all monitoring results in the control unit 20 after the transmission of the monitoring result information to the driving behavior model management server for assuring storage capacity.

The driving behavior model management server having received the monitoring result information, stores the monitoring results in the received monitoring result information inside by associating them with the transmission source address of the received monitoring result information. Subsequently, the driving behavior model management server creates a second driving behavior model using all monitoring results (or monitoring results in the fixed period of time) associated with the transmission address of the presently received monitoring result information. Then, when a new second driving behavior model can be created, the driving behavior model management server sends back the new second driving behavior model to the sender of the presently received monitoring result information. On the contrary, when a new second driving behavior model cannot be created, the driving behavior model management server sends back information showing that a new second driving behavior model is not created to the sender of the presently received monitoring result information. Note that a new second driving behavior model is defined as either of a second driving behavior model that is different from the previously created second generated driving behavior model for the sender of the presently received monitoring result information or a second driving behavior model for the sender of the presently received monitoring result information which is created for the first time.

As is clear from the above operation of the driving behavior model management server, the control unit 20 having finished transmission of the monitoring result information to the driving behavior model management server, receives the second driving behavior model or the information showing that the new second driving behavior model is not created. When receiving the second driving behavior model, the control unit 20 replaces the driving behavior model (the first or second driving behavior model) stored in each of the volatile storage and the non-volatile storage 21 with the received second driving behavior model. Then, the control unit 20 becomes in a state where it performs the safe driving behavior notification processing using the replaced second driving behavior model. On the other hand, when receiving the information showing that that the new second driving behavior model is not created, the control unit 20 performs nothing. That is, in this case, the control unit 20 uses the same driving behavior model (the first or second driving behavior model) so far to perform the safe driving behavior notice processing.

Hereinafter, the safe driving behavior notification processing (FIG. 2) will be explained. Note that, the driver of the subject vehicle will hereinafter also be termed the target driver.

As shown in the Figure, the control unit 20 having started the safe driving behavior notification processing, to begin with, creates an obstacle map based on information detected by the obstacle detection unit 11 (step S101). The obstacle map created in this step S101 is a map showing position and category (human, vehicle, fixed object such as a guardrail) of each obstacle existing in front of the subject vehicle.

Then, the control unit 20 creates a risk potential map by calculating risk potentials around each obstacle based on the created obstacle map (step S102). Risk potentials in the risk potential map created in this step S102 are numerically converted values of moving range and movability of each obstacle, which are obtained in consideration of the differences (variations) in movability. The difference in movability by the movement direction is obtained using an action prediction model corresponding to the category of the obstacle. That is, for example, in the case where an obstacle existing in front of the subject vehicle is a human and it is predicted that there is a high possibility that the human moves to the right direction by the action prediction model for human, the risk potential map in which risk potentials of the right direction of the human are high is created in step S102.

The control unit 20 having finished the creation of the risk potential map searches for a traveling route that the subject vehicle should take in future using information (size of the subject vehicle, relationship between operation quantity of the steering wheel and actual turning angle and the like) related to the subject vehicle and the created risk potential map (step S103). The traveling route that is searched for in step S103 is a route consisting of low risk potential positions in the risk potential map. Accordingly, the driver can evade potential hazards by driving the subject vehicle so as to run on the traveling route. Note that information that is really obtained in step S103 is information containing position of the subject vehicle in every prescribed time interval (e.g., one second).

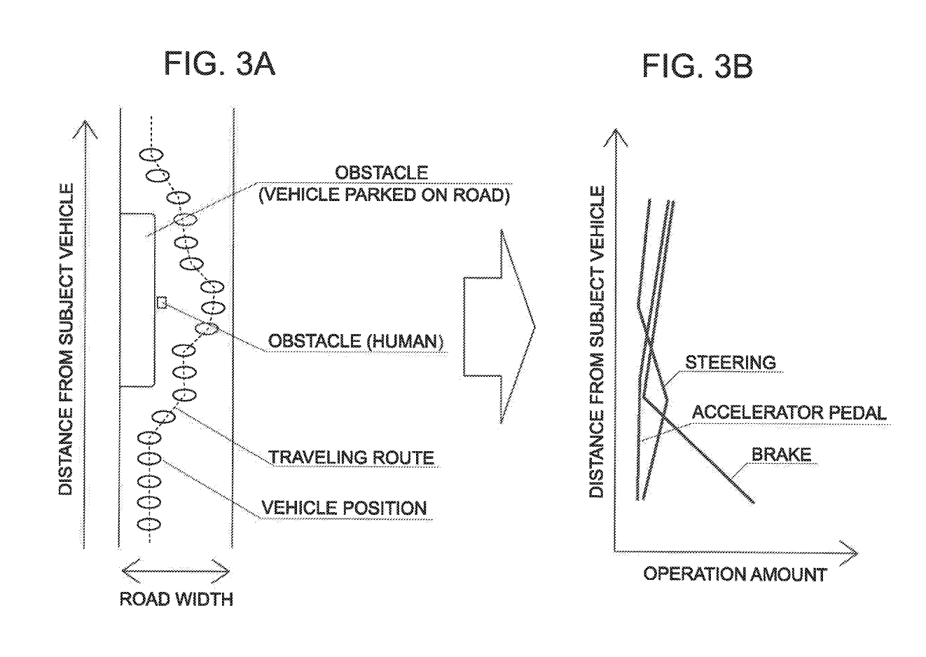

The control unit 20 having finished the search of the traveling route that the subject vehicle should take, specifies the driving behavior that the driver should carried out to make the subject vehicle run along the traveling route (step S104). For example, in the case where the traveling route illustrated in part (a) of FIG. 3 is searched for in step S103, the driving behavior (time-series data of the operation quantities of the brake pedal, the accelerator pedal and the steering wheel) illustrated in part (b) of FIG. 3 is specified in step S104.

After finishing the processing of step 401, the control unit 20 predicts the driving behavior of the target driver to the present conditions from the position of each obstacle, the information (vehicle speed, operation quantity of the steering wheel and the like) on the travel state of the subject vehicle using the driving behavior model for the target driver (step S105). As mentioned before, the driving behavior model used in step S105 is the first driving behavior model or second driving behavior model. Further, the first driving behavior model is a model that estimates a representative driving behavior of the drivers whose driver information are identical with or similar to the driver information of the target driver without considering the physical condition of the target driver. Accordingly, in the case where the driving behavior model is the first driving behavior model, the representative driving behavior of the drivers whose driver information are identical with or similar to the driver information of the target driver is predicted based on positions of obstacles existing around the subject vehicle, the vehicle speed and the like without considering the physical condition of the target driver.

On the other hand, when the driving behavior model is the second driving behavior model, in step S105, the driving behavior of the target driver is predicted by using also the information indicating the physical condition of the target driver. Moreover, the second driving behavior model is a model created from the past driving behavior of the target driver so that the driving behavior of the target driver can be predicted in consideration of the physical condition of the target driver. Consequently, by the processing of step S105 after the driving behavior model is changed to the second driving behavior model, it is possible to predict the driving behavior of the target driver correctly (with less prediction error) even when the target driver feels sick or he driving behavior of the target driver is peculiar one.

After finishing the processing of step S105, the control unit 20 determines whether or not notification to the driver is required based on the degree of the difference between the driving behavior that is searched for in step S104 and the driving behavior that is predicted in step S105 (step S106). Here, the degree of the difference between the two driving behavior is defined, for example, as the sum of distances between vehicle positions in the respective time while the two driving behavior are carried out, the square sum of distances between vehicle positions in the respective time while the two driving behavior are carried out, etc. In step S106, it is determined that the notification is not required when the degree of the difference between the two driving behavior is equal to or smaller than (or smaller than) a preset threshold, and it is determined that the notification is required otherwise.

When determining that the notification to the driver is not required (step S107; NO), the control unit 20 terminates the safe driving behavior notification processing (processing of FIG. 2).

On the other hand, when determining that the notification to the driver is required (step S107; YES), the control unit 20 specifies information that should be notified to the driver and a notification method of the information based on the degree of the difference of the two driving behavior, the auditory load and the visual load of the driver (step S108). Then, the control unit 20 notifies the driver of the specified information (step S109) and subsequently terminates this safe driving behavior notice processing.

Hereinafter, the processing of step S108 and S109 will be described further in detail.

In step S108, the auditory load is obtained as a numerical value within the rage from 1 to 3 (larger value shows higher auditory load) based on the information detected by the auditory load detection unit 13. Further, the visual load is obtained as a numerical value within the rage from 1 to 3 (larger value shows higher visual load) based on the number of the detected obstacles. Note that, it is possible to obtain the visual load based on the pattern of the visual axis movement that can be detected from information from a camera (e.g. the camera arranged as physical condition detection unit 12) which is arranged in the subject vehicle to photograph the state of the driver.

In the processing of step S108, the information that should be notified to the driver and the notification method of the information is specified so that notification by the text message(s) decreases as the auditory load increases, attention-seeking ability of notification increases as the degree of the difference of the two driving behavior.

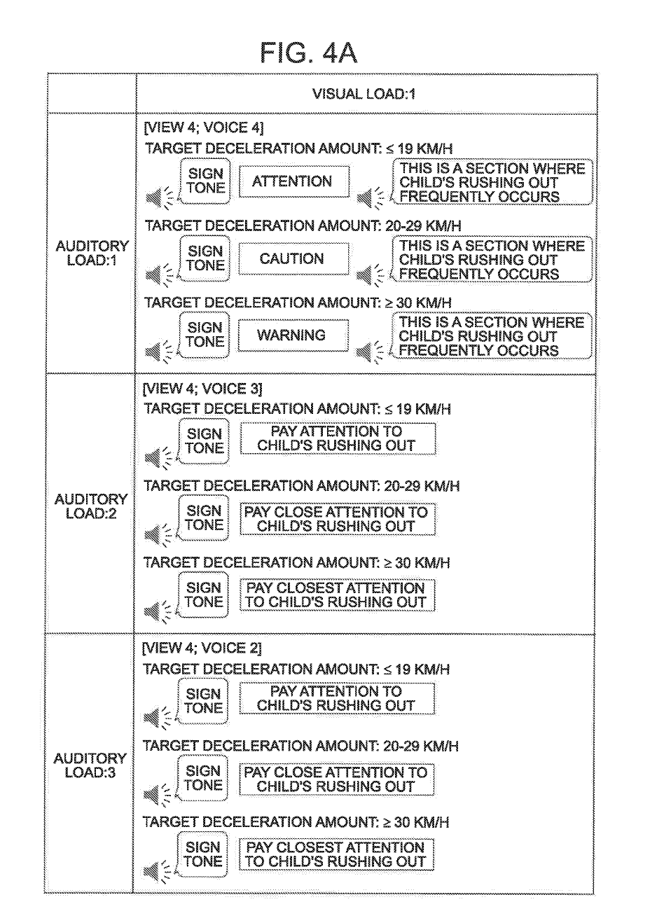

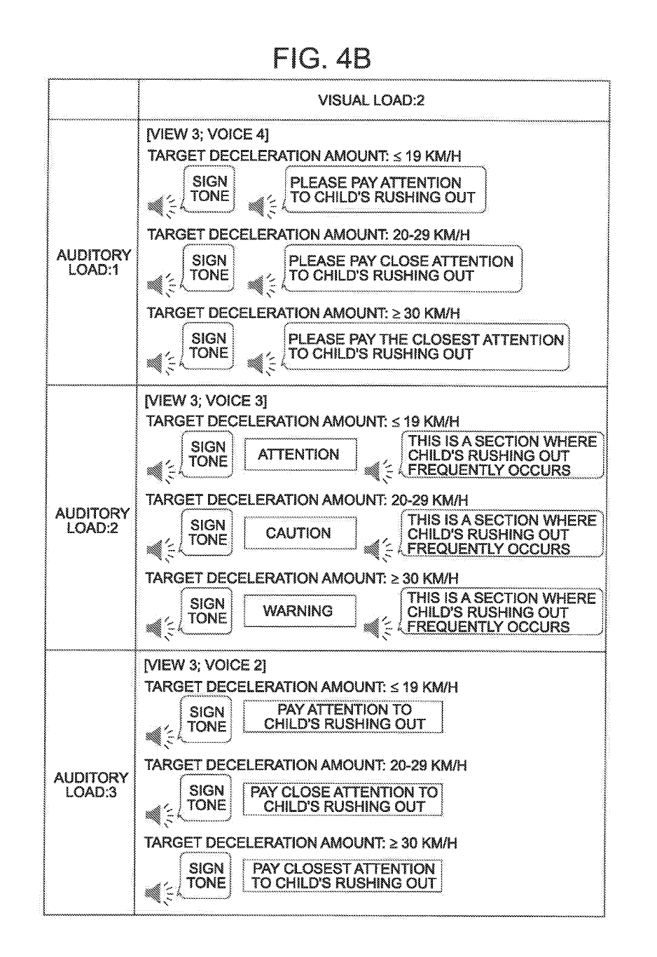

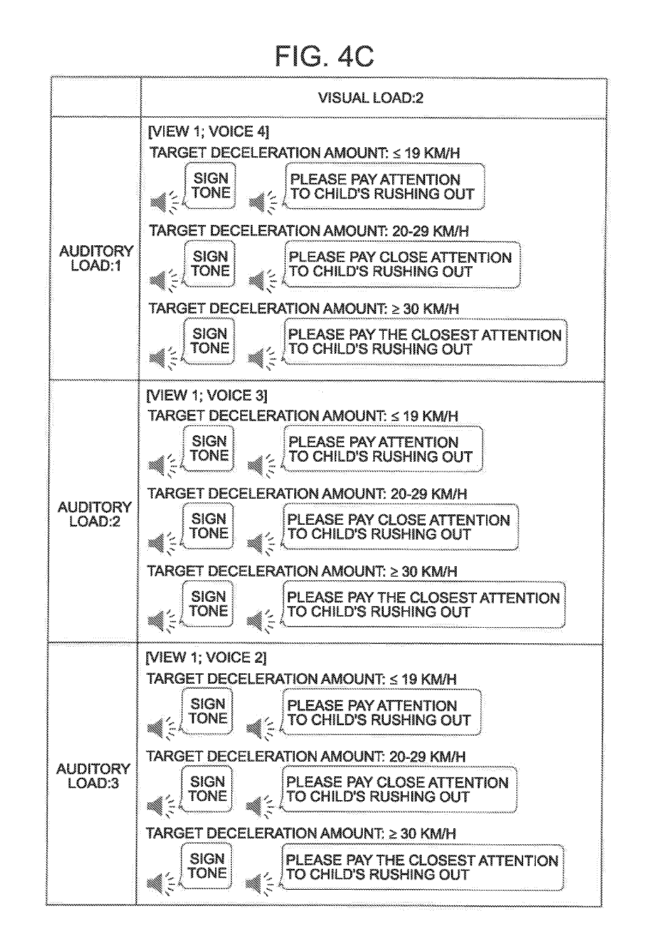

Specifically, for example, in the case where deceleration is recommended, one of notification process shown in FIGS. 4A through 4C is performed depending on a combination of the auditory load, the visual load and a target deceleration amount. Note that the target deceleration amount is an integer value that can be obtained by subtracting a deceleration amount of the driver, which is predicted using the driving behavior model, from a recommended deceleration amount (a value which is obtained from the processing result of step S104) and rounding off one decimal place.

Namely, as shown in FIGS. 4A through 4C, usable levels (“4” in “VIEW 4”, “4” in “VOICE 4”, etc. in FIGS. 4A through 4C) of the display unit 15 and the voice output unit 16 are assigned to each combination of the auditory load and the visual load calculated in the processing of step S108. Here, the usable level is defined as information that the usable levels 1 to 4 indicate “not usable”, “not usable if there is a substitute”, “usable, but recommended not to use” and “usable”, respectively. Moreover, as shown in FIGS. 4A through 4C, one notification process is allocated to each combination of the usable level of the display unit 15, the usable level of the voice output unit 16 and range of the target deceleration amount.

That is, as shown in FIG. 4A, in the case where the usable level of each of the display unit 15 and the voice output unit 16 is “4” (each of the auditory load and the visual load is “1”) and the target decorrelation amount is equal to or smaller than 19 km/h, it is prescribed to perform the notification process of outputting a sign tone to inform that there is a notification and a text (text message) “ATTENTION”, and then outputting voice message “THIS IS A SECTION WHERE CHILD'S RUSHING OUT FREQUENTLY OCCURS”. In the case where the usable level of each of the display unit 15 and the voice output unit 16 is “4” and the target decorrelation amount is within the rage from 20 to 29 km/h, it is prescribed to perform the notification process of outputting the sign tone and a text “CAUTION”, and then outputting voice message “THIS IS A SECTION WHERE CHILD'S RUSHING OUT FREQUENTLY OCCURS”. Further, in the case where the usable level of each of the display unit 15 and the voice output unit 16 is “4” and the target decorrelation amount is equal to or larger than 20 km/h, it is prescribed to perform the notification process of outputting the sign tone and a text “WARNING”, and then outputting voice message “THIS IS A SECTION WHERE CHILD'S RUSHING OUT FREQUENTLY OCCURS”. Note that, although not shown in FIGS. 4A through 4C, “ATTENTION”, “CAUTION” and “WARNING” are displayed with a yellow background, an orange background and a red background, respectively, in order that attention-seeking ability of notification increases as the degree of the difference of the two driving behavior. In each of other cases where the usable level of the display unit 15 is not “1”, the notification process by which text is displayed is performed as shown in FIGS. 4B and 4C.

In the case where the usable level of the display unit 15 is “1” (the visual load is “3”), the notification process by which text is not displayed is performed as shown in FIG. 4C. In this case, with the increase in the target deceleration amount, the voice message, the voice message is changed as follows.

### “PLEASE PAY THE CLOSEST ATTENTION TO CHILD'S RUSHING OUT”

### “PLEASE PAY CLOSE ATTENTION TO CHILD'S RUSHING OUT”

### “PLEASE PAY ATTENTION TO CHILD'S RUSHING OUT”

In cases where the usable level of the voice output unit 16 is “2” (in cases where the auditory load is “3”), the voice message is omitted (not used) generally. However, in cases where it is not preferable to display text (in cases where the usable level of the display unit 15 is “1”), the notification process by which the voice message is used is performed even if the usable level of the voice output unit 16 is “2” as shown in FIG. 4C.

In step S108, the notification process associated with the combination of the auditory load, the auditory load and the target deceleration amount. is selected from the notification processes of which processing procedures are set as mentioned above. Then, in step S109, the selected notice process is performed.

Hereinafter, complementary explanation will be made relating to the control unit 20.

Although not shown in the flow chart (FIG. 2), the control unit 20 performs reaction monitoring processing of monitoring reaction of the driver until a prescribed time passes since the processing of step S107 is executed. The reaction monitored by the reaction monitoring processing is driving operation, speech and facial expression of the driver. The control unit 20 adds a predetermined value to the threshold that is used in the processing of step S106 when the driver performs action or utterance indicating that he/her feels the notification is troublesome during the above prescribed time. That is, the driver who feels that the notification is troublesome may produce sounds showing the effect or screw up his/her face. When detecting such reaction, the control unit 20 increases the threshold, thereby reducing the likelihood that the notification will occur. Then, the control unit 20 terminates the reaction monitoring processing.

Further, the control unit 20 subtracts a predetermined value from the threshold that is used in the processing of step S106 when a start of the driving control of the driver is delayed due to the absence of the notification. That is, the control unit 20 decreases the threshold in order to increase the likelihood that the notification will occur. Then, the control unit 20 terminates the reaction monitoring processing.

Further, at the time of the processing of step S106, the control unit 20 adds a value representing the degree of the difference of the two driving behavior to a held value that control unit 20 holds for calculating a value representing a driving level. Note that the initial value (value at the time when the control unit 20 starts its operation; the time is usually simultaneous with ON of the ignition key) of the held value is “0”.

Moreover, the control unit 20 calculates the value representing the driving level of the driver from the held value at that point of time and the execution number of times of the safe driving behavior notification processing when detecting that the ignition key is turned off. Then, the control unit 20 notifies the driver of the value through the display unit 15, and finishes its operation.

As discussed above, the safe driving behavior notification system according to the embodiment has a function of determining whether or not notification to the driver is required based on the comparison result of the driving behavior to be carried out by the driver which is obtained from position of each obstacle and the driving behavior of the driver which is predicted using the driving behavior model (the second behavior model) that is created from the past driving behavior of the driver. By using the driving behavior model that is created from the past driving behavior of the driver, it is possible to predict the driving behavior of the driver precisely compared to when using other driving behavior models (for example, driving behavior model for average drivers who are close in age). Consequently, according to the safe driving behavior notification system of the present embodiment, it is possible to prevent useless notification from being given to the driver.

Further, although the driving behavior of the driver may vary by his/her physical condition, the second driving behavior model is a model to predict the driving behavior in consideration of the physical condition of the driver. Consequently, according to the safe driving behavior notification system of the present embodiment, it is possible to prevent useless notification from being given to the driver without depending on the physical condition of the driver
Furthermore, the safe driving behavior notification system computes direction in which each obstacle is likely to move using the action prediction model, and creates the risk potential map having large risk potentials in the direction obtained for each obstacle. The risk potential map created by such procedure shows potential danger at each point precisely compared to the potential risk map (denoted hereinafter as the conventional map) created without taking each direction in which each obstacle is likely to move into consideration. Therefore, the driving behavior specified from the above risk potential map becomes one that is more correct than the driving behavior specified from the conventional map. Consequently, the safe driving behavior system operates as a system in which necessity of the notification is not erroneously determined due to the inaccurate driver behavior being specified.

Further, the safe driving behavior notification system determines notification procedure (selects notification process) so that the visual/auditory load of the driver does not increase excessively. Therefore, with the safe driving behavior notification system, it is possible to notify the driver of information for safe driving (danger avoidance) so that the driver can securely grasp the information without feeling that the notification is troublesome.

Furthermore, the safe driving behavior notification system has a function to change the threshold that is used for the determination of the necessity of the notification based on the reaction of the driver while the notification is made and the reaction of the driver while the notification is not made. Therefore, with the safe driving behavior notification system, it is possible to automatically change the notification timing to the timing that is appropriate to the driver.

### <<Modifications>>

The sage driving behavior notification system discussed above may be modified in a variety of forms. For example, the safe driving behavior notification system can be modified to the system in which the second driving behavior model is created by the control unit 20.

In place of the second driving behavior model, a driving behavior model which is created based on the past driving behavior of the driver and which does not take the physical condition of the driver into consideration, may be employed. However, the sage driving behavior notification system which uses the above driving behavior model instead of the second driving behavior model operates as a system which cannot notify the driver the information for safe driving at the timing considering the physical condition of the driver. Therefore, It is therefore preferable to adopt the above second driving behavior model.

The safe driving behavior notification system may be modified to a system that specifies the driving behavior to be carried out by the driver without using the above risk potential map (e.g. system specifies the driving behavior based on positions of obstacles). It is possible to add the safe driving behavior notification system (the control unit 20) a function of reducing amount of information to be informed to the driver with the lapse of the operation time of the safe driving behavior notification system (e.g. a function of shifting to a state where notification by the voice message is not made when the operation time reaches to a specified time).

What is claimed is:

1. A safe driving behavior notification system to be equipped in a vehicle, comprising:
an obstacle detector configured to detect position of each obstacle existing around a subject vehicle;
a first specifier configured to specify driving behavior to be carried out by a driver of the subject vehicle based on the position of each obstacle detected by the obstacle detector and information relating to the subject vehicle;
a second specifier configured to specify driving behavior predicted to be carried out by the driver from the position of each obstacle detected by the obstacle detector and information on a travel state of the subject vehicle using a driving behavior model for the driver which is created based on past driving behavior of the driver; and
a notificator configured to determine whether notification to the driver is necessary, based on a degree of a difference between the driving behavior specified by the first specifier and the driving behavior specified by the second specifier, and to notify the driver of information indicating action to be carried out by the driver, when it is determined that the notification to the driver is necessary.

2. The safe driving behavior notification system according to claim 1, further comprising a physical condition detector configured to detect physical condition of the driver,
wherein the driving behavior model is created based on the past driving behavior of the driver and physical condition of the driver at the time of each driving behavior, and
wherein the second specifier is configured to specify the driving behavior predicted to be carried out by the driver from the position of each obstacle detected by the obstacle detector, the physical condition detected by the physical condition detector and the information on the travelling state of the subject vehicle using the driving behavior model.

3. The safe driving behavior notification system according to claim 1,
wherein the obstacle detector is configured to detect position and category of each obstacle existing around the subject vehicle, and
wherein the first specifier is configured to specify the driving behavior to be carried out by the driver based on a risk potential map that is created such that risk potential for each area to which each obstacle moves with high possibility is high and the information on the travelling state of the subject vehicle.

4. The safe driving behavior notification system according to claim 1,
wherein the notificator is configured to determine whether the notification to the driver is necessary by determining whether the degree of the difference is equal to or smaller than a threshold value, and
wherein the safe driving behavior notification system further comprises a threshold changer configured to monitor reaction of the driver for a prescribed period of time after determination of the necessity of notification is made by the notificator.

5. The safe driving behavior notification system according to claim 1, further comprising a load detector configured to detect an auditory load and a visual load of the driver; and
wherein the notificator is configured to include a text display function to notify the driver of the information indicating the action to be carried out by the driver through text message and a voice output function to notify the driver of the information indicating the action to be carried out by the driver through voice message, and to notify, when the auditory load detected by the load detector is equal to or larger than a first predetermined load, the driver of the information indicating the action to be carried out by the driver using, without using the voice output function, the text display function.

6. The safe driving behavior notification system according to claim 5,
wherein the notificator is configured to notify the driver of the information indicating the action to be carried out by the driver using, without using the text display function, the voice output function when the visual load detected by the load detector is equal to or larger than a second predetermined load and the auditory load detected by the load detector is smaller than the first predetermined load, and to notify the driver of the information indicating the action to be carried out by the driver using, without using the voice output function, the text display function when the visual load detected by the load detector is smaller than the second predetermined load and the auditory load detected by the load detector is equal to or larger than the first predetermined load.

7. A safe driving behavior notification method carried out by a computer for notifying a driver in a subject vehicle of information indicating action to be carried out by the driver, the method comprising:
a first specifying step of specifying driving behavior to be carried out by the driver based on position of each obstacle existing around the subject vehicle and information relating to the subject vehicle;
a second specifying step of specifying driving behavior predicted to be carried out by the driver from the position of each obstacle detected by the obstacle detector and information on a travel state of the subject vehicle using a driving behavior model for the driver which is created based on past driving behavior of the driver; and
a notification step of determining whether notification to the driver is necessary based on a degree of a difference between the driving behavior specified in the first specifying step and the driving behavior specified in the second specifying step, and of notifying the driver of information indicating action to be carried out by the driver when it is determined that the notification to the driver is necessary.
